(19) United States
(12) Patent Application Publication
(10) Pub. No.: US 2015/0158022 A1
(43) Pub. Date: Jun. 11, 2015

(54) METHOD OF MAKING METAL OXIDE CATALYSTS USING TEMPLATES

(71) Applicant: Brunel University, Uxbridge, Middlesex (GB)

(72) Inventors: Paul Sermon, Uxbridge (GB); Myles Worsley, Uxbridge (GB)

(21) Appl. No.: 14/409,759

(22) PCT Filed: Jul. 3, 2013
(86) PCT No.: PCT/GB2013/051770

§ 371 Date: Dec. 19, 2014

(30) Foreign Application Priority Data
Mar. 7, 2012 (GB) 1211792.5

(51) Int. Cl. B01J 35/00; B01J 37/02; C02F 1/32; C01G 23/07; B01J 35/02; C02F 1/72; B01J 37/08; B01J 21/06

(52) U.S. Cl. CPC B01J 35/004; B01J 37/082; B01J 37/0238; B01J 21/063; C01G 23/07; B01J 35/02; B01J 37/0215; C02F 1/725; C02F 1/32; C02F 2101/308

(57) ABSTRACT

A method of producing a catalyst, comprises the steps of: (a) applying to a template (such as a bio-template) a metal alkoxide or a metal halide; (b) reacting the metal alkoxide or metal halide to form a metal oxide catalyst; and, optionally, (c) removing the template from the metal oxide catalyst of step (b). The resulting biomimetic metal oxide has been found to have excellent catalytic (especially photocatalytic) properties.

The present invention relates to methods for making catalysts (such as photocatalysts). In particular it relates to methods for making photocatalysts from photoactive transitional metal semiconductor oxides. More particularly, the invention relates to titanium dioxide photocatalysts and methods for making them.

In the text below, [n] refers to reference number n in the list which appears at the end of the description.

TiO₂ is a well-known photocatalyst [1] with excitation producing an e_{CB}⁻.h_{VB}⁺ pair [2], where the excited electron can transfer to an acceptor and the positive hole can accept an electron from a donor. It can thereby photomineralize organic and NOₓ pollutants [3], photoreduce CO₂ [4] or photocatalytically split H₂O [5]. It can be improved by an adsorbed dye sensitizer [6], surface Pt [7], N-[8]/B-[9]/transition-metal-[10]/lanthanide ion-doping [11] or by lowering its particle size [12].

There are patent applications and papers on new solid TiO₂ photocatalysts that aim for them to absorb and be activated in the visible spectral range. Sol-gel derived TiO₂ quantum-sized nanoparticulate photocatalysts [13] have in recent years developed into non-stoichiometric TiSiₓN_{y}O_{2+2x-y} (where 0.01<x<1 and 0.003<y<0.3) [14] and mixed-phase TiO₂-based photocatalysts with a red-shift [15] that are active in the UV-visible spectral regions. Certainly CdS/Au/TiO_{1.96}C_{0.04} absorbs into the visible spectrum [16]. Apatite precipitated onto the surface of commercial TiO₂ in simulated body fluid is an improved catalyst for CH₃CHO decomposition [17]. Some have produced dendritic TiO₂ (or GeO₂) on templates [18]. It is known that the TiO₂ structure matters. For example, anatase (band gap 3.2 eV; absorption edge 380 nm; work function 5.1 eV) crystallites have higher photocatalytic activity than rutile (band gap 3.02 eV; absorption edge 415 nm; work function 4.9 eV [19]) ones in the photocatalysed decolouration of methyl orange (MO) [20]. Interestingly, 100-120 nm thick anatase overlayers grown on rutile produce hetero-junctions that exhibit even higher pseudo-first-order rate constants and rates of photocatalysed dye decolouration [21]. Certainly the activity of anatase and brookite films in photodegradation of 2-propanol is higher than for rutile [22].

The present invention seeks to establish a new route to photocatalysts (and catalysts) with improved performance and efficiency.

In a first aspect of the present invention, there is provided a method of producing a catalyst, comprising the steps of:

(a) applying to a template a metal alkoxide or a metal halide;

(b) reacting the metal alkoxide or metal halide to form a metal oxide catalyst.

Step (b) preferably comprises a hydrolysis-condensation reaction in which the metal alkoxide or metal halide is reacted with surface —OH groups of bound water on the template to form a metal oxide catalyst. Without wishing to be constrained by theory, it is thought that the possible reaction schema are as follows (for a tetravalent metal ion)—

Reaction of metal alkoxide with (1) water and (2) hydroxyl ions:

M(OR)₄+2H₂O→MO₂+4ROH (1)

M(OM)₄+4—OH→—(O)₄—M+4ROH (2)

Reaction of metal halide with (1) water and (2) hydroxyl ions:

MX₄+2H₂O→MO₂+4HX (3)

MX₄+4—OH→—(O)₄—M+4HX (4)

In a preferred embodiment, the method additionally comprises the step of:

(c) removing the template from the metal oxide catalyst of step (b).

Preferably, the method comprises the step of coating a template or bio-template structure with a metal oxide using its alkoxides or halides in solution or in the gas phase to produce (after hydrolysis-condensation and drying) a metal oxide/template or a metal oxide/bio-template composite of varying metal oxide loading and thickness. The alkoxide (e.g. Ti(OC₃H₇)₄) or halide (e.g. TiCl₄) may for example be those of Ti (titanium), but those of other photoactive semiconductor metal oxides (e.g. ZnO, WO₃, MoO₃, and other oxides of Sn, Zn, Mo and W etc) may be used. The metal oxide is formed by reaction of template or bio-template surface —OH groups or bound/adsorbed water with a metal alkoxide (e.g. Ti alkoxides) delivered by (i-iii) below or halide (TiCl₄) or another suitable precursor impregnated into the template or bio-template.

The template may include (but is not restricted to) synthetic polymer fibres, dispersed micro- or nano-droplets from an emulsion or microemulsion, a ceramic foam or monolith, a metal or alloy foil or monolith, or any solid surface.

The bio-template may include (but is not restricted to) butterfly wing (or fish) scales, pollen grains, wood, paper or card (corrugated or not), cellulose, spherobacterium, human or animal hair, filaments from a spider's web.

The oxide overcoats may preferably be about 40-250 nm thick (τ), but can be up to 3-5 μm thick (τ).

The oxide overcoats can be coated as single layers or in combinations or compounds, homogeneously or in multilayer stacks (e.g. TiO₂—SiO₂). These can be made non-stoichiometric, doped sometimes to form phosphors, or sensitised to tune the wavelength of operation to the photon energy and pollutants of interest.

Optionally the template or bio-template surface structure is first coated with polyvinyl alcohol (PVA)-acetate (alone or in conjunction with other polymers or nanoparticles (NPs)) or a polyol, for example from a 0-10 wt % aqueous solution which, after drying, acts as an in-situ hydrolysing agent in that its —OH groups can then react with alkoxides or halides in the vapour or solution phase to produce controlled metal oxide coatings by reaction with the metal alkoxides or halides.

The oxide overcoats may preferably be about 40-250 nm thick (τ), but may be up to 3-5 μm thick (τ).

The oxide overcoats can be coated as single layers or in combinations or compounds, homogeneously or in multilayer stacks (e.g. TiO₂—SiO₂). These can be made non-stoichiometric, doped to form phosphors, or sensitised to tune the wavelength of operation to the photon energy and pollutants of interest.

In one embodiment, the template or bio-template surface structure may be first coated with polyvinyl alcohol (PVA)-acetate (alone or in conjunction with other polymers or nanoparticles (NPs)) or a polyol, deposited for example from a 0-10 wt % aqueous solution which, after drying, acts as an in-situ hydrolysing agent in that its —OH groups can then react with the metal alkoxides or halides in the vapour or solution phase to produce the controlled metal oxide coatings by reaction with the metal alkoxides or halides.

Optionally other alkoxides (e.g. those of Si, Hf, Zr, Ta, Sc, etc (and other metals that form the body of knowledge known as sol-gel chemistry)), halides or dopant salts may also be present and incorporated to fine-tune the doped-TiO₂ overlayers. The replica may also benefit from doping by inorganic residues from the bio-template.

The template, polyol/template, bio-template or polyol/bio-template may be removed (for example by calcining) to result in a hollow replica. The hollow replica may be intentionally fractured.

The photoactive metal oxide on the template, bio-template, polyol/template or polyol/bio-template may be optionally coated with a SiO₂ layer, for example, by reaction with Si alkoxides or halides in solution or the vapour phase.

The method may comprise the step of coating the template or bio-template with a polyol and, after drying, reacting this with the alkoxides of Al, Zr, Si, Ti and other metals that form the body of knowledge known as sol-gel chemistry.

The template may include (but is not restricted to) synthetic polymer fibres, dispersed micro- or nano-droplets from an emulsion or microemulsion, a ceramic foam or monolith, a metal or alloy foil or monolith, or any solid surface.

The bio-template may include (but is not restricted to) butterfly wing (or fish) scales, pollen grains, wood, paper or card (corrugated or not), cellulose, spherobacterium, human or animal hair, filaments from a spider's web.

Selected templates, polyol-coated templates, bio-templates and polyol-coated bio-templates can be oxide overcoated by:

(i) infiltration with alkoxide or halide solutions of 0.1-35 mM concentration optionally with other components, where alcohols are an example of suitable solvents, or

(ii) infusion with alkoxides or halide solutions of 0.1-35 mM concentration optionally with other components in supercritical alkoxide fluids, or

(iii) infusion with alkoxide or halide as vapours optionally with other components at 1-100 kPa at a temperature at which the template, bio-template, PVA or polyol is thermally stable

to give oxide overcoats that are 40 nm to 5 μm thick (τ) after hydrolysis and drying. (i-iii) are simpler and more scalable preparative routes than methods such as atomic layer deposition (ALD).

Both the oxide-overcoated templates and bio-templates, oxide replicas and fractured replicas can be incorporated into paints, surface coatings and surface treatments that promote pollutant or greenhouse gas adsorption and removal or facilitate process chemistry and photocatalysed process chemistry or that act as smart sensors. Here, a fractured hollow replica with a photoactive inner TiO₂ film and an outer SiO₂ film that protects the coating or paint from TiO₂-induced degradation is beneficial. These paints, surface coatings and surface treatments are active in photocatalytic removal of pollutants from air and water and in photocatalysed process chemistry.

Alternatively a macroscopic solid surface can be the template, which can be polyol or PVA-coated and then treated with Ti alkoxide or halide as in (i-iii) and after hydrolysis and drying a TiO₂ overcoat is produced.

The present invention should be seen against a background of biomimetic chemistry. This started in the realm of organic chemistry [23] (e.g. biomimetic photocatalysts are often based on complexes and artificial enzymes, such as Ru-based artificial enzymes [24], biomimetic hydrogenase mimics [25], di-iron hydrides [26], porphyrins (free and bound) [27], natural prototype in leaves [28] and phthalocyanines (HMS-FePcs [29] and mesoporous FePcS/SiO₂ [30])) but has progressed to benefit the design of materials and heterogeneous catalysts.

Now we know that objects can be made to mimic molecules (e.g. the surface-held polyol or PVA on the template and bio-template surfaces [31]).

This uses plant and animal bio-templates which have evolved [32] intricate nano-architectures that are the envy of materials scientists [33]. Thus ZrO₂ microspheres can be produced from pollen bio-templates [34], biomimetic silica [35] exists, chitosan-capped CdS and bio-templated Pt/PdS/CdS water-splitting composites can be produced [36] and biomimetic Bi₂WO₆ templated on butterfly wings showed improved visible light absorption [37].

It is known that one can overcoat some of nature's millions [38-40] of bio-templates that are available on Earth with inorganic phases to form novel hybrid nanostructures [41] and then remove the bio-template to produce novel intricate replicas [42].

However, the present approach is not limited to bio-templates. It is believed that this method has not up to now been used to prepare designer solid photocatalysts and catalysts with templates, bio-templates, polyol/PVA-coated templates and polyol/PVA-coated bio-templates.

In a further aspect of the invention, there is provided a method of producing a photocatalyst comprising the step of coating a bio-template structure with a metal oxide to produce a metal oxide/ bio-template composite and removing the bio-template to result in a hollow replica.

### Alternative Routes to the Present Approach to Biomimetic Replicas and Photocatalysts.

An alternative high energy route to biomimetic replicas is to use atomic layer deposition (ALD). Some have used peptide fibre templates [43] for the production of hollow TiO₂ replicas. These were prepared by sequential NH₃ and Ti(iOC₃H₇)₄ ALD cycles at 0.4 kPa and 413K that gave an overcoat of tetragonal anatase (i.e. 10-20 nm thick in 500-1000 ALD cycles taking 80 min [44]) on lyophilized peptide assemblies that were then calcined to 673K to give hollow nanoribbons 150 nm wide with a 10 nm wall thickness. The advantage and novelty of our approach is that in one step (whatever the template or bio-template surface chemistry, whether it is bio or synthetic) we can through the choice of PVA/polyol loading and Ti alkoxide type and concentration deliver
(a) 10 nm-1 μm thick TiO₂-based coatings (with a range of dopants)
(b) on any size sample
(c) in the form of continuous replica films or holey structures (which are better photocatalytically) and
(d) at lower temperatures (that suit some delicate temperature-sensitive templates and bio-templates (e.g. spider's web)

ALD has been used to produce alumina overlayered butterfly wing scales [45]. ALD only delivers TiO₂ coatings using complex cycles (i.e. Ti(iOC₃H₇)₄-H₂O cycles [46] or TiCl₄ and H₂O cycles [47]).

Others have used low energy infiltration routes to low activity biomimetic TiO₂ based pollen bio-templates [48], but that was without the PVA/polyol-fine tuning of bio-template TiO₂ surface sol-gel chemistry that was used here.

Naturally PVA-TiO₂ interactions are well known, but not in the specific context of the in-situ surface-held hydrolysing reactant described here.

Thus pre-formed TiO₂ nanoparticles (NPs) have been used to form membranes [49] and coatings [50] in the presence of PVA. In addition TiO₂/PVA [51] and TiO₂/PVA/carbon [52] mixtures have been carbonised to give carbon-coated TiO₂ NPs of raised photocatalytic activity in water pollution control. However, the PVA merely acts as a binder [53] rather than being a pivotal in-situ alkoxide-hydrolysing agent as seen in the present work, where it induces the TiO₂ nanoparticulate coating to form. Others have judged that the TiO₂ NPs were simply electrostatically immobilised on the PVA [54]. This is very different from the present invention, where the PVA pre-coating is intentionally-initiating the formation of TiO₂ overcoat and then covalently binds this (before the PVA-template or PVA-bio-template is removed by calcination).

A number of preferred embodiments of the invention will now be described with reference to the drawings, in which:

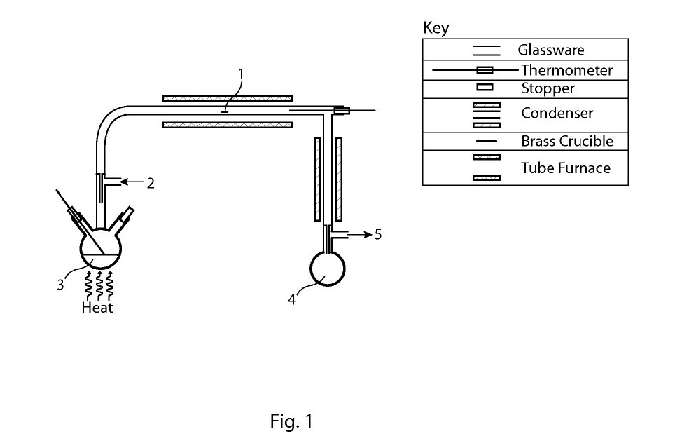

FIG. 1 is a schematic diagram of a reflux-furnace CVD system which can be used in a method in accordance with the invention;

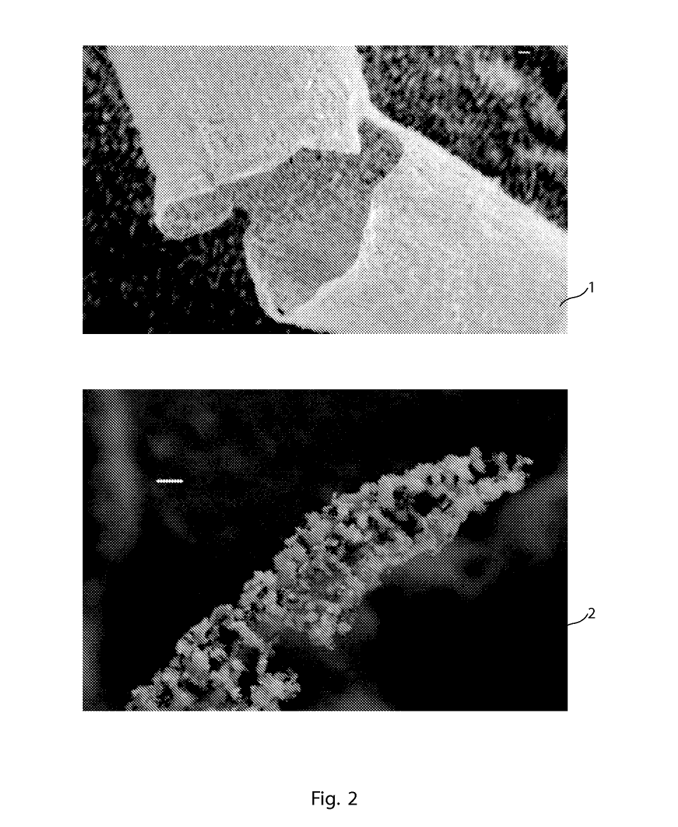

FIG. 2 shows examples of PVA-bio-templates and PVA-templates that have been TiO₂ overcoated and then calcined to produce TiO₂ replicas in accordance with the invention.

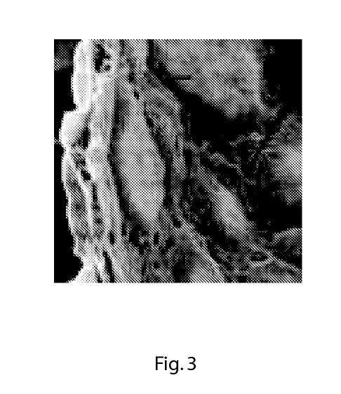

FIG. 3 shows a finely-detailed hollow TiO₂-overcoated pollen grain of Lilium longiflorum (LL) in accordance with the invention.

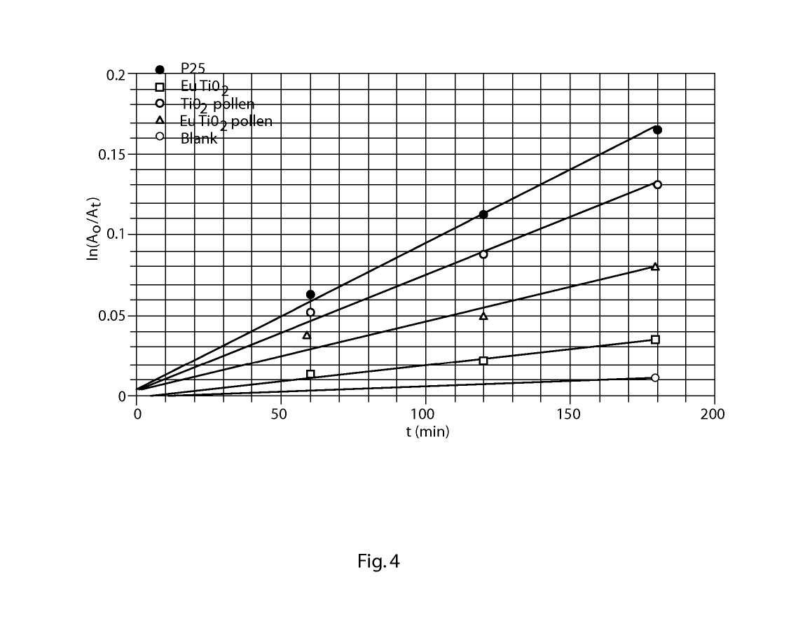

FIG. 4 is a graph showing the photocatalytic activities and selectivities of the biomimetic TiO₂-based material coatings; and

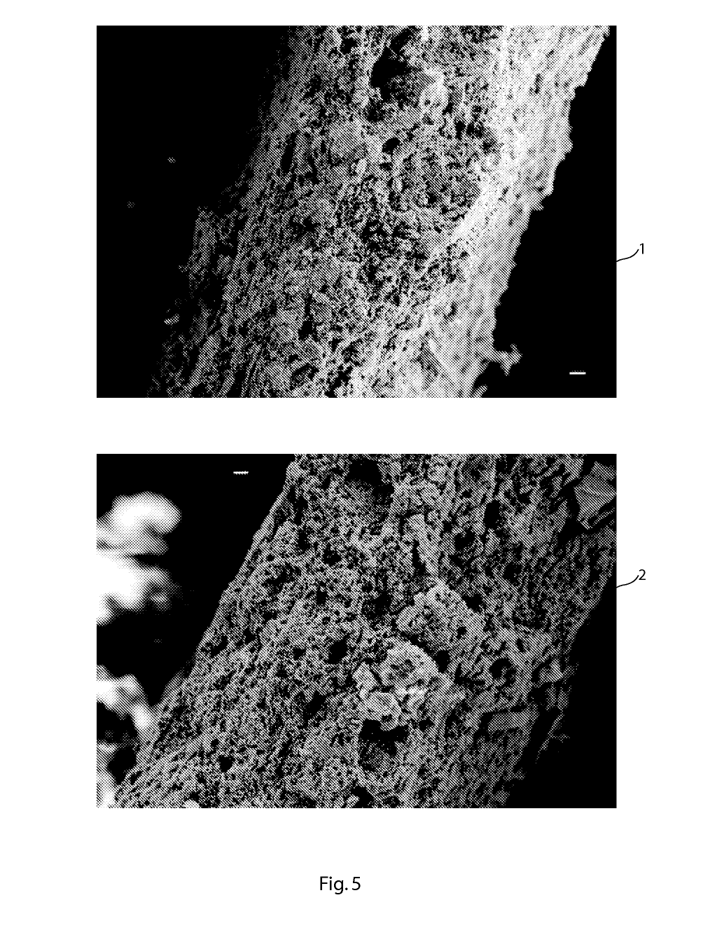

FIG. 5 shows alumina overcoating of PVA/ceramic monoliths in accordance with the invention.

### EXAMPLE

Selected templates and bio-templates were titania (that is, titanium dioxide) overcoated by

(i) infiltration with alcoholic Ti-alkoxide solutions of 0.1-35 mM concentration,

(ii) infusion with Ti-alkoxides in supercritical fluids or

(iii) infusion with Ti-alkoxides as vapours at 1-100 kPa

to give oxide overcoats 40 nm to 3-5 μm thick (τ).

The following is an example of the preparation, testing and properties of a biomimetic TiO₂-based material and hollow replica photocatalyst.

(a) Preparation

To prepare the biomimetic hollow TiO₂ replica photocatalyst in this example, an alkoxide (Ti(OR)₄) was reacted with the template-held water (equation 1) and template surface —OH groups (equation 2) on the bio-template pollen and then atmospheric moisture to produce a TiO₂ coating, whose thickness (τ) could be controlled.

Ti(OR)₄+2H₂O→TiO₂+4ROH (1)

Ti(OR)₄+4—OH→—(O)₄—Ti+4ROH (2)

As an alternative method, an anhydrous solution or the vapour phase of TiCl₄ was reacted via reactions (3) and (4) with surface hydroxyl (—OH) or bound water on the templates, PVA/templates, bio-templates and PVA/bio-templates to give surface-bound TiO₂ species:

TiCl₄+2H₂O→TiO₂+4HCl (3)

TiCl₄+4—OH→—(O)₄—Ti+4HCl (4)

(i) Immersion Preparation

A sample of Lilium longiflorum (LL) pollen was placed in a sample bottle. To this 3 cm³ of the alkoxide solution (in ethanol) at the relevant concentration was added and left to react for 2 h, during which time the reacted pollen was dispersing in the solvent. The solvent was allowed to evaporate in air and the surface of the pollen grains was allowed to react with moisture in the atmosphere to give TiO₂/LL pollen bio-composites. Then the product was heated at 5° C. min⁻¹ in air to 800° C. (at which temperature it was held for 15 h before cooling to give fine hollow TiO₂ replicas that were readily re-dispersed for inclusion in coatings. Varying the alkoxide solution concentration allowed τ to be varied. Addition of europium ions in the alkoxide solution allowed Eu-doping and phosphor formation.

(ii) CVD Preparation

Chemical vapour deposition (CVD) was also used with equal success. Here the vapour of the chosen alkoxide, titanium isopropoxide (Ti(OR)₄), from a refluxing flask was passed over the LL pollen in a tubular furnace through which N₂ was passing for 1 h at 250° C. Since Ti(OR)₄ reacts readily with the water in air and has a flash point of ˜45° C., the apparatus (see FIG. 1) was made gas-tight and flushed with N₂ for 15 min prior to the CVD experiment. For the experiment a constant flow of nitrogen was used. The alkoxide was heated to 228° C. and the pollen in the furnace was heated to 250° C. at a rate of 20° C. min⁻¹. The reactant masses and volumes and temperatures are given in Table 1:

TABLE 1
Experimental parameters

| | | |
|---|---|---|
| Ti(OR)₄ vol. | 6 | cm³ |
| Pollen mass | 20 | mg |
| N₂flow rate | 10 | cm³ · min⁻¹ |
| Furnace temp. | 250° | C. |
| ^{L}exit gases temp. | ~220° | C. |
| Reflux Flask temp. | 228° | C. |
| ^{L}time to get there | ~15-20 | min |

After 1 h the heating mantle and furnace were switched off, but the flow of N₂ and the water coolant in the condenser was maintained for a further 15 h. After reacting with moisture in the atmosphere this also produced TiO₂/LL pollen bio-composites. Again the product was heated at 5° C. min⁻¹ in air to 800° C. (at which temperature it was held for 15 h) before cooling to give fine hollow TiO₂ replicas that were readily re-dispersed for inclusion in coatings. Varying the CVD time allowed τ to be varied; 1 h CVD was satisfactory.

Other templates, bio-templates, PVA-templates and PVA-bio-templates were also successfully TiO₂ over-coated (see FIG. 2).

(b) Measurement of Photocatalytic Removal of Methyl Orange from Water at 25° C.

To assess the photocatalytic degradation of methyl orange (MO) by the TiO₂ biomimetic replicas (pre-calcined at 800° C.) and commercial TiO₂ (P25), an aqueous 0.1 mM methyl orange (MO) solution and the redispersed TiO₂ (0.15±0.01 mg cm⁻³) were mixed. A quartz cuvette containing 1 cm³ of the MO solution and 0.5 cm³ of the TiO₂ suspension was gently agitated and UV-vis spectra were measured as a function of time (0 h<t<3 h) at 25° C. A blank measurement was also undertaken. MO concentrations were estimated as a function of time and analysed in terms of rate constants and rates normalised per unit area of TiO₂.

(c) Properties

Hollow biomimetic TiO₂ replicas (after removal of the bio-template by calcination) were intricate and finely detailed (see FIG. 3).

These biomimetic TiO₂-based biomimetic replica materials were used dispersed in solution and were also incorporated into photoactive coatings that control air and water pollutant levels and their properties have been compared with those of commercial TiO₂ nanoparticulates (e.g. P25). They were also characterized by X-ray (XRD) and electron diffraction (ED) [55], TEM-EELS, SEM-EDX and XPS. The biomimetic TiO₂-based materials consisted of a modified anatase structure.

The photocatalytic activities and selectivities of the biomimetic TiO₂-based material coatings were studied in the control of air pollutants (toluene, HCHO, NOₓ) and water pollutants (0.1 mM methyl orange [56], benzene, toluene, phenol, alkyl phenol and alkyl phenol ethoxylates) (see results for methyl orange removal from water in FIG. 4 and Table 2 below).

TABLE 2
First-order rate constants and normalised rates per unit area for
photodegradation of 0.1 mM methyl orange in water at 25° C.
with a 0.5kW UV-visible light source

| | | Normalised |
|---|---|---|
| H₂O solution/dispersions | k₁ × 10⁻⁴ (mm⁻¹) | rates/mm² |
| Blank H₂O | 0 602 | — |
| P25 | 9.121 | 1.000 |
| Eu—TiO₂ powder | 1.943 | 0.722 |
| Biomimetic TiO₂/LL pollen replica | 7.169 | 5.458 × 10⁶ |
| Biomimetic Eu—TiO₂/LL pollen replica | 4.258 | 3.242 × 10⁶ |

Rates per unit area were very much faster on the hollow biomimetic TiO₂-based replica coatings than for commercial TiO₂ nanoparticulate coatings (P25), but Eu-addition to form a phosphor was not especially helpful (but other phosphor-inducing dopants are beneficial). It is believed that this is because of the local structure, doping and multifaceted nanostructure of the biomimetic TiO₂-based materials, replicas and coatings. Doping, varying non-stoichiometry and using multicomponent oxide coatings with TiO₂ and SnO₂, ZnO, MoO₃, WO₃, etc) will all allow these photocatalysts to be used effectively in pollution controlling paints (for indoor and outdoor use) in offices, animal houses, laboratories, factories, etc. in water channels and ducting. The hollow biomimetic TiO₂-based materials, replicas and coatings may also be useful in TiO₂ photoanodes in solar cells [57], photocatalysts for CO₂ reduction and water splitting, fuel cell electrodes and antibacterial coatings.

The photoactivities of replicas based on TiO₂/PVA/Twaron® aromatic polyamide fibre and TiO₂/PVA/human hair in methyl orange removal were higher than those based on TiO₂/pollen as a result of their novel geometries.

Even TiO₂/PVA/template or bio-template coatings on glass, metallic, alloy and ceramic mimicking their surfaces showed good photoactivity when prepared as described, with or without PVA removal.

Immobilised TiO₂/PVA/Twaron® (where k₁=386×P25 rate constant), TiO₂/PVA/rattan (where k₁=181×P25 rate constant) and TiO₂/PVA/spider's web filament (where k₁=63×P25 rate constant) replicas, formed when held on fused silica surfaces at 873K in air for 10 h, were more active in the photodegradation of 0.1 mM methyl orange in aqueous solution than dispersed in P25 TiO₂ alone. Indeed they showed bigger differences in first order rate constants than those seen in Table 2.

Catalysts

Other templates, bio-templates, PVA-templates and PVA-bio-templates were also Al₂O₃ overcoated using Al(iOC₃H₇)₃. A ceramic monolith for example was alumina overcoated (see FIG. 5) to give a useful and novel heterogeneous catalyst substrate.

### REFERENCES

(first author only given for brevity)
[1] Linsebigler Chem. Rev. 95, 735, (1995)
[2] Banerjee Curr. Sci. (Bangalore) 90, 1378, (2006)
[3] Allen Polym. Degrad. Stab. 93, 1632, (2008)
[4] Inoue Nature 277, 637, (1979)
[5] Fujishima Nature 37, 238, (1972)
[6] Vlachopoulos J. Amer. Chem. Soc. 110, 1216, (1988)
[7] Sato Chem. Phys. Lett. 72, 83, (1980)
[8] di Valentin Phys. Rev. 70B, 085116, (2004)
[9] Yang Phys. Rev. 76B, 195201, (2007)
[10] Li Phys. Rev. 79B, 201204, (2009)
[11] Saif Inorg. Chim. Acta 360, 2863, (2007)
[12] Xu Mater. Sci. Eng. 56B, 211, (1999)
[13] Park U.S. Pat. No. 6,566,300, (2003)
[14] Iwamoto U.S. Pat. No. 7,153,808, (2006)
[15] Chen U.S. Pat. No. 8,202,820, (2012)
[16] Yun ACS Nano 5, 4084, (2011)
[17] Soysal J. Ceram. Proc. Res. 12, 176, (2011)
[18] Sewell Dalton Trans. 29, 3857, (2008)
[19] Tanaka Chem. Phys. Lett. 187, 73, (1991)
[20] Sreekantan Thin Solid Films 518, 16, (2009)
[21] Romero-Gomez Chem Phys Chem 12, 191, (2011)
[22] Addamo Chem. Commun. 4943, (2006)
[23] Franck Angew. Chem. Int. Edn. 14, 819, (1975)
[24] Herrero Coord. Chem. Rev. 252, 456, (2008)
[25] Wang ACS Catal. 2, 407, (2012); Kluwer Proc. Natl. Acad. Sci. USA 106, 10460, (2009)
[26] Wang J. Amer. Chem. Soc. 134, 4525, (2012)
[27] Maldotti Green Chem. 3, 42, (2001); Farhadi J. Chem. Res. 3, 157, (2011); Maldotti J. Biol. Inorg. Chem. 4, 154, (1999)
[28] Zhou J. Mater. Chem. 19, 2695, (2009)
[29] Gao Chin. J. Catal. 29, 426, (2008); Gao Chin. J. Catal. 29, 397, (2008)
[30] Gao Acta Phys. Chim. Sinica 26, 2437, (2010)
[31] N. B. Bowden, M. Weck, I. S. Choi and G. M. Whitesides Acc. Chem. Res. 34, 231, (2001)
[32] Sarikaya Nature Materials 2, 577, (2003)
[33] Mann J. Mater. Res. 23, 3137, (2008)
[34] Yang J. Nanosci. Nanotechnol. 11, 10369, (2011)
[35] Yuan J. Nanotechnol. 2, 760, (2011)
[36] Jiang 3rd Internat. Conf. Bioinform. Biomed. Eng. 1-11, 5120, (2009); He 15-ICC poster 1-05-7843, (2012)
[37] Yao Mater. Lett. 77, 21, (2012)
[38] Barthlott Beilstein J. Nanotechnol. 2, 135, (2011)
[39] Heuer Science 255, 1098, (1992)
[40] Mora PLoS Biology 9(8): e1001127. doi: 10.1371, (2011)
[41] Colfen Angew. Chem. Int. Edn. 42, 2350, (2003)
[42] Cheng Developments in Porous, Biological and Geopolymer Ceramics 28, 209, (2008)
[43] Han J. Mater. Chem. 19, 3512, (2009)
[44] Leskela Thin Solid Films 409, 138, (2002)
[45] Huang Nano Lett 6, 2325, (2006); Knez Adv. Mater. 19, 3425, (2007)
[46] Knez Nano Lett 6, 1172, (2006)
[47] King Adv. Mater. 18, 1561, (2006)
[48] Hall Chem. Mater. 18, 598, (2006)
[49] Pourjafar Desalination 315, 107, (2013); Pourjafar J. Ind. Eng. Chem. 18, 1398, (2012); Aminabhavi Polymer 13, 497, (2010); Li Trans. Chin. Soc. Agric. Eng. 21, 1, (2005)
[50] Liu Water Res. 46, 1969, (2012); Revuru Recent Trends Adv. Mater. 584, 396, (2012); Hede Ind. Eng. Chem. Res. 48, 1893, 1905, 1914, (2009); Liu J. Central South Univ. Technol. 14, 386, (2007); Chu Coll. Surf. 302A, 1, (2007); Chu J. Coll, Interf. Sci. 297, 215, (2006); U.S. Pat. No. 3,352,708; Mallakpour Progr. Org. Coatings 71, 391, (2011)
[51] Matsunaga Appl. Catal. 64B, 9, (2006); Kim J. Mater. Sci. 43, 6486, (2008); Toyoda J. Photochem. Photobiol. 171A, 167, (2005); Tryba Appl. Catal. 50B, 177, (2004); Inagaki, Carbon 42, 3153, (2004); Inagaki Carbon 41, 2619, 92003)
[52] Howard 14^{th} Int. Cong. Catal. Seoul (2008)
[53] Zhang Appl. Surf. Sci. 254, 1771, (2008); Doushita J. Sol-gel Sci. Technol. 22, 91, (2001)
[54] Matsuzawa Appl. Catal. 83B, 39, (2008)
[55] Thamaphat Kasetsart J. 42, 357, (2008)
[56] Ma Appl. Phys. 104A, 365, (2011)
[57] Zhang Chem. Mater. 21, 33, (2009)

1. A method of producing a catalyst, comprising the steps of:
(a) applying to a template a metal alkoxide or a metal halide;
(b) reacting the metal alkoxide or metal halide to form a metal oxide catalyst.

2. A method as claimed in claim 1, wherein step (b) comprises a hydrolysis-condensation reaction.

3. A method as claimed in claim 1, wherein the metal alkoxide or metal halide of step (a) is in solution or in the gas phase.

4. A method as claimed in claim 1, additionally comprising the step of:
(c) removing the template from the metal oxide catalyst of step (b).

5. A method as claimed in claim 4, wherein in step (c) the template is calcined in order to remove it.

6. A method as claimed in claim 4, additionally comprising the step of:
(d) fracturing the product of step (c).

7. A method as claimed in claim 1, wherein the template is a bio-template.

8. A method as claimed in claim 7, wherein the bio-template is formed from butterfly wing scales, fish scales, pollen grains, wood, paper, card, cellulose, spherobacterium, human or animal hair, or filaments from a spider's web.

9. A method as claimed in claim 1, wherein the metal oxide is a photoactive transition metal semiconductor oxide.

10. A method as claimed in claim 9, wherein the metal oxide is an oxide of titanium, zinc, tungsten, molybdenum, aluminium or tin.

11. A method as claimed in claim 1, wherein steps (a) and (b) are independently repeated to result in multiple layers of metal oxide (which may the same or different) on the template.

12. A method as claimed in claim 1, additionally comprising the step of applying silicon dioxide to the template before the metal alkoxide or a metal halide is applied in step (a) or applying silicon dioxide to the metal oxide/template product of step (b).

13. A method as claimed in claim 12, wherein the silicon dioxide is formed by applying a silicon alkoxide or halide and then carrying out a hydrolysis-condensation reaction to form silicon dioxide.

14. A method as claimed in claim 1, additionally comprising the step of applying to the template a polyvinyl alcohol acetate or a polyol or a combination thereof before the metal alkoxide or a metal halide is applied in step (a).

15. A method as claimed in claim 14, additionally comprising the step of drying the polyol with an alkoxide of aluminium, silicon or zirconium.

16. A catalyst obtainable via a method as claimed in claim 1.

17. A method of catalyzing a reaction, the method comprising contacting regeants for the reaction with a catalyst produced by the method as claimed in claim 1.
